(19) United States
(12) Patent Application Publication
(10) Pub. No.: US 2015/0099098 A1
(43) Pub. Date: Apr. 9, 2015

(54) COMPOSITE TEXTILE

(71) Applicants: Concrete Canvas Ltd., Pontypridd (GB); Milliken & Company, Spartanburg, SC (US)

(72) Inventors: Pradipkumar BAHUKUDUMBI, Greenville, SC (US); Randolph S. KOHLMAN, Boiling Springs, SC (US); Mark A. HORNUNG, Campobello, SC (US); Peter BREWIN, Cardiff (GB); William CRAWFORD, Cardiff (GB)

(73) Assignees: Concrete Canvas Ltd., Pontypridd (GB); Milliken & Company, Spartanburg, SC (US)

(21) Appl. No.: 14/048,630

(22) Filed: Oct. 8, 2013

(51) Int. Cl. B32B 5/26; B32B 5/02

(52) U.S. Cl. CPC B32B 5/26; B32B 5/028; B32B 2250/05; B32B 2305/18; B32B 2307/546; B32B 2307/54; B32B 2307/718; B32B 2307/7265; B32B 2307/724
USPC 428/190

(57) ABSTRACT

A flexible textile or cloth is provided that can be hardened to a rigid or semi-rigid condition. The textile can incorporate reinforcement fibers to provide improved mechanical properties. The reinforcement fibers can be added in a various configurations without unnecessarily increasing the weight of the textile. Further, the textile can include at least one flap to facilitate readily joining the textile with another component such as another textile to create a composite construction.

### TECHNICAL FIELD

The subject matter of the present disclosure relates generally to an improved, composite textile that can become rigid or semi-rigid by e.g., applying a liquid or radiation.

### BACKGROUND

A flexible textile or cloth that can be positioned into a desired shape or configuration and then caused to harden or rigidify upon e.g., the application of a liquid (such as water) or radiation has numerous applications and benefits. For example, the textile can be positioned to form a structure and then hardened to provide a protective hard armor barrier. Similarly, the textile can be deployed to form e.g., a temporary roadway, temporary wall, erosion barrier, waste containment structure, temporary or permanent form work, structural liner for piping or culverts, and numerous other applications. Multiple sheets of such textile may be used together depending upon e.g., the size of the application.

As such, depending upon the intended application, it is desirable to be able to provide such a textile that can be readily manufactured in various customized sizes and thicknesses. The ability to provide such a textile having improved mechanical properties such as e.g., improved strength is also desirable. Such a textile having an improved ability to join or combine multiple sheets of such textile while maintaining the overall strength of the combined sheets would also be very useful.

The textile may be deployed e.g., in emergency situations or otherwise dangerous environments. For example, the textile may installed and used in a combat zone or in an area where a natural disaster has occurred. In such situations, minimizing the exposure of personnel during installation and/or utilizing the hardened textile as quickly as possible may be paramount. Thus, a textile having a capability to be rapidly installed and set is highly desirable.

Additionally, deployment may occur where only a minimal amount of construction equipment and skilled labor are available. A settable textile that can be readily deployed in a straightforward manner in such situations would also be useful. For example, a textile constructed in sheets that can be more easily joined would be very beneficial. A settable textile that can be lighter, and therefore readily moved and positioned while also having the desired mechanical strength, would improve both manufacturing and installation processes.

### SUMMARY OF EXEMPLARY EMBODIMENTS OF THE INVENTION

The present invention provides a flexible textile or cloth that can be hardened to a rigid or semi-rigid condition while providing certain advantages including those as set forth above. The textile can incorporate reinforcement fibers to provide improved mechanical properties. The reinforcement fibers can be added in various configurations without unnecessarily increasing the weight of the textile. Further, the textile can include at least one flap to facilitate readily joining the textile with another component such as another textile to create a composite. Additional objects and advantages of the invention will be set forth in part in the following description, or may be apparent from the description, or may be learned through practice of the invention.

In one exemplary embodiment, the present invention provides a flexible textile that can be set to become rigid or semi-rigid. The flexible textile includes a first face; a second face separated from the first face by a space; and a textile body including supporting fibers extending between the first and second faces and maintaining the first and second faces in a spaced-apart arrangement. A powder material is located in the space between the first and second faces. The powder material is capable of setting to a rigid or semi-rigid solid on the addition of a liquid or when exposed to radiation. A reinforcement layer is located on at least the first or second face. At least a portion of the reinforcement layer extends past the textile body to define a flap.

In another exemplary embodiment, the present invention provides a rigid or semi-rigid textile that includes a first face; a second face separated from the first face by space; and a textile body having supporting fibers extending between the first and second faces and maintaining the first and second faces in a spaced-apart arrangement. A rigid or semi-rigid solid is located in the space between the first and second faces. A reinforcement layer is located on at least the first or second face. At least a portion of the reinforcement layer extends past the textile body to define a flap.

In another exemplary embodiment, the present invention provides a flexible textile composite that can be set to become rigid or semi-rigid. The textile composite includes a first flexible textile that can be set to become rigid or semi-rigid and a second flexible textile that can be set to become rigid or semi-rigid. The first flexible textile and the second flexible textile each includes a first face; a second face separated from the first face by a space; a textile body includes supporting fibers extending between the first and second faces and maintaining the first and second faces in a spaced-apart arrangement; and a powder material located in the space between the first and second faces, wherein the powder material is capable of setting to a rigid or semi-rigid solid on the addition of a liquid or when exposed to radiation. The first flexible textile further includes a reinforcement layer located on at least the first or second face of the first flexible textile, wherein at least a portion of the reinforcement layer extends past the textile body of the first flexible textile to define a flap that overlaps at least a portion of the textile body of the second flexible textile.

In another exemplary embodiment, the present invention provides a rigid or semi-rigid textile composite that includes a first rigid or semi-rigid textile and a second rigid or semi-rigid textile. The first rigid or semi-rigid textile and the second rigid or semi-rigid textile each include a first face; a second face separated from the first face by a space; a textile body including supporting fibers extending between the first and second faces and maintaining the first and second faces in a spaced-apart arrangement; and a rigid or semi-rigid solid located in the space between the first and second faces. The first rigid or semi-rigid textile further includes a reinforcement layer located on at least the first or second face of the first rigid or semi-rigid textile. At least a portion of the reinforcement layer extends past the textile body of the first rigid or semi-rigid textile to define a flap that overlaps at least a portion of the textile body of the second rigid or semi-rigid textile.

In another exemplary embodiment, the present invention provides a flexible textile that can be set to become rigid or semi-rigid. The textile includes a first face; a second face separated from the first face by a space; and a textile body including supporting fibers extending between the first and second faces and maintaining the first and second faces in a spaced-apart arrangement. At least one of the first or second faces extends past the textile body to define a flap. A powder material located in the space between the first and second faces and is capable of setting to a rigid or semi-rigid solid on the addition of a liquid or when exposed to radiation.

In still another exemplary embodiment, the present invention provides a rigid or semi-rigid textile that includes a first face; a second face separated from the first face by space; and a textile body including supporting fibers extending between the first and second faces and maintaining the first and second faces in a spaced-apart arrangement. At least one of the first or second faces extends past the textile body to define a flap. A rigid or semi-rigid solid is located in the space between the first and second faces.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE FIGURES

An exemplary embodiment of the present invention will now be described by way of example, with reference to the accompanying figures, wherein:

FIGS. 1 through 4 are illustrations of cross-sectional views of exemplary embodiments of a textile of the present invention.

FIG. 5A illustrates a perspective view of another exemplary embodiment of the present invention having metal reinforcement. FIG. 5B is a photograph of an exemplary embodiment of the present invention having metal reinforcement.

FIGS. 6 and 7 are illustrations of cross-sectional views of additional exemplary embodiments of a textile of the present invention.

FIG. 8 illustrates another exemplary textile of the present invention as may be joined to another component such as e.g., another textile.

FIGS. 9 and 10 are illustrations of cross-sectional views of additional exemplary embodiments of a textile of the present invention.

FIG. 11 illustrates a cross-sectional view of an exemplary embodiment of a textile composite of the present invention.

FIGS. 12 through 15 are plots of certain data as more fully described herein.

The use of the same reference numerals in different figures denotes same or similar features.

### DETAILED DESCRIPTION

For purposes of describing the invention, reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

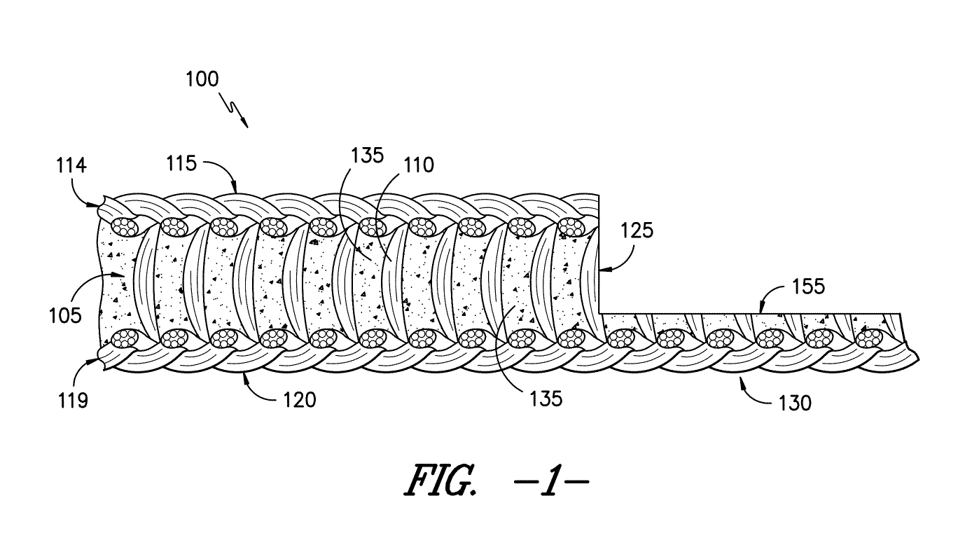

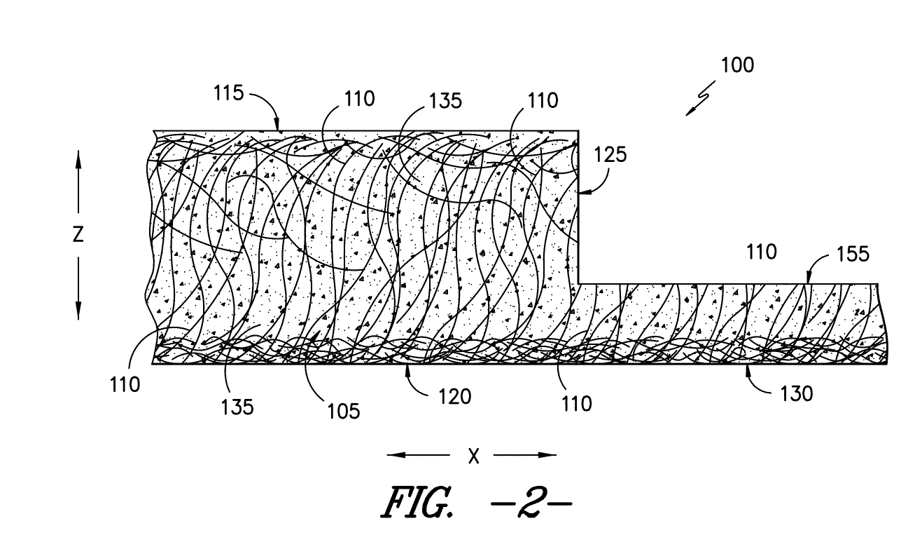

FIG. 1 illustrates a first exemplary embodiment of a textile 100 of the present invention that can be flexible and, after application of a liquid and/or radiation, can become rigid or semi-rigid. Textile 100 includes a first face 115 separated from the second face 120 by a space. In this space, textile 100 includes a textile body 105 having supporting fibers 110 that extend between first face 115 and second face 120 to maintain faces 115 and 120 in the spaced-apart relationship.

For the exemplary embodiment of FIG. 1, before forming into a desired structure or configuration, textile body 105 can exist in the form of e.g., a sheet that defines a plane extending along the X direction within textile body 105. Second face 120 of textile body 105 extends past an edge 125 of textile body 105 to define a flap 130. The extension of second face 120 to define flap 130 is provided by way of example only as flap 130 could also be formed by extending first face 115. As will be further described herein, flap 130 can be used to join textile 100 with another component such as e.g., another textile constructed similarly to textile 100.

The textile body 105 may be formed from any suitable textile having fibers 110 that extend between first face 115 and second face 120 to maintain faces 115 and 120 in the spaced-apart relationship. In one embodiment, the textile body 105 is a spacer fabric. The spacer fabric contains two textile layers 114 and 119 that form first face 115 and second face 120, respectively, with supporting fibers 110 connecting between the two layers 114, 119. In one exemplary embodiment, as depicted in FIG. 1, the spacer fabric is a knit spacer fabric such that the textiles forming the first face 115 and the second face 120 are in a knit construction.

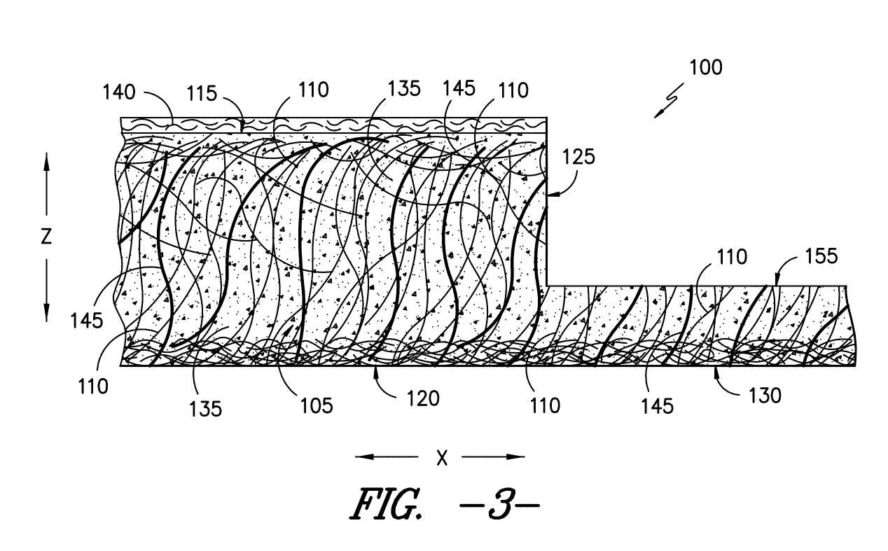

In another embodiment, as shown in FIG. 2, the textile body 105 is formed from a non-woven textile. The non-woven textile contains supporting fibers 110 oriented generally in the z-direction (the z-direction is defined as the direction perpendicular to the plane formed by the first and second faces 115, 120). The z-orientation of the supporting fibers 110 allows for increased thickness and higher compression resistance and retention of loft (also referred to as retention of thickness) during handling and subsequent filling of a settable powder (discussed below). Preferably, a majority of the supporting fibers 110 have a tangential angle of between about 25 and 90 degrees to the normal of the first and second faces measured at the midpoint between the faces. This means that if a tangent was drawn on the fibers at the midpoint between the faces, the angle formed by the tangent and the plane formed by the first face 115 would be between about 90 degrees and 25 degrees. More preferably, the angle formed by the tangent and the plane formed by the first face would be between about 90 degrees and 45 degrees.

Supporting fibers 110 span the entire thickness of textile body 105 and often have a length along the z-direction that exceeds the distance between first and second faces 115 and 120. Supporting fibers may consist of multiple fibers that are bonded together such that there is a continuous linkage of fibers between surface 120 and 115. As shown near second face 120, some of the supporting fibers 110 may be oriented along the x-direction or have a portion of their length that is oriented along the x-direction. This edge effect can increase the density of the supporting fibers 110 along second face 120 as shown.

The non-woven textile body 105 may contain binder fibers which are heated to bond the supporting fibers together for greater compression resistance and retention of loft during handling and subsequent filling of settable powder. Examples of heat activated binder fibers are fibers that can melt at lower temperatures such as low melt fibers, bi-component fibers, such as side-by-side or core and sheath fibers with a lower sheath melting temperature, and the like. In one exemplary embodiment, the binder fibers are a polyester core and sheath fiber with a lower melt temperature sheath.

In one exemplary embodiment, the non-woven textile body 105 is formed using a K-12 HIGH-LOFT RANDOM CARD by Fehrer AG (Linz, Austria). In another exemplary embodiment, the non-woven textile body 105 is formed using a Strudo, vertical lapper technology which takes a non-woven and folds or pleats it to produce a vertically folded product of given thickness where the majority of supporting fibers 110 have a tangential angle of between about 25 and 90 degrees to the normal of the first and second faces measured at the midpoint between the faces.

With either of the exemplary embodiments shown in FIGS. 1 and 2, textile body 105 is formed from supporting fibers 110 that provide spaces or voids for the introduction of a powder material 135. Fibers 110 are self-supporting and should be sufficiently stiff, i.e. they should be sufficiently resistant to bending under forces tending to crush the textile body, so as to maintain the spacing between faces 115 and 120 when powder material 135 is loaded into textile body 105. When it is said that the fibers 110 are self-supporting, this includes embodiments where the fibers individually are not self-supporting, but the collection of fibers 110 is self-supporting. The density of the supporting fibers 110, i.e. the number of fibers (or yarns) per unit area, is also an important factor in resisting crushing forces while the powder material 135 is added, in maintaining the spacing between faces 115 and 120, and in restricting the movement of the particles forming powder material 135 once they are trapped between first face 115 and second face 120. It is preferable that the supporting fibers 110 do not divide the space within textile body 105 into individual small closed compartments. Such a division may potentially allow cracks to propagate within textile body 105 and reduce its strength once powder material 135 has set to a rigid or semi-rigid solid between first face 115 and second face 120.

A variety of different materials may be used for supporting fibers 110. In one exemplary embodiment, supporting fibers 110 are a monofilament yarn as this provides the greatest stiffness for textile body 105. In one embodiment, supporting fibers 110 are hydrophilic to allow wicking of water during hydration of the settable powder. It is also desirable that supporting fibers 110 are chemically resistant to powder material 135. Suitable fibers for use as supporting fibers 110 forming textile body 105 include polypropylene fibers, which have excellent chemical resistance to alkaline conditions present when powder material 135 is a cement; coated glass fibers, which can provide reinforcement to the powder material; polyethylene fibers; polyvinylchloride (PVC) fibers, which have the advantage of being relatively easy to bond using chemical or thermal bonding; polyethylene terephthalate (PET) fibers, polyvinyl alcohol (PVA) fibers, carbon fibers, and others.

As stated, a powder material 135 is located in the space between first face 115 and second face 120 and resides in the spaces or voids in textile body 105. Powder material 135 is capable of setting so that textile body 105 includes a rigid or semi-rigid body between first face 115 and second face 120. Powder material 135 may be settable on the addition of a liquid such as e.g., water, and in one embodiment may comprise cement, optionally together with sand or fine aggregates and/or plasticizers and other additives found in cement or concrete compositions that will set to solid cement or concrete on the addition of water or a water-based solution. Alternatively, powder material 135 may be a UV settable material or one component of a multi-part curable resin that cures when two or more liquid components are mixed together, e.g., an epoxy resin system. Other components may be used for powder material 135 as well.

The amount of powder material 135 placed into the spaces or voids of textile body 105 is preferably such that, particularly when the material has set, it occupies substantially the whole of the space between first and second faces 115 and 120. Powder material 135 should be readily loadable into textile body 105 and, in the case that it is hardened by the addition of a liquid, the liquid can rapidly penetrate between the powder particles to form a composition that will set over time. Powder material 135 and/or the liquid combined therewith can include additives, e.g., foaming agents, fillers, reinforcement materials, etc., that are known in the art in connection with the settable materials concerned.

The settable powder material 135 is preferably added to the space through pores formed in first face 115 of textile body 105; in which case, first face 115 will have pores that are large enough to allow powder material 135 to be placed in textile body 105. In the preferred embodiment, the average pore size of face 120 is less than the average pore size of face 115. However, after placement in textile body 105, it is desirable to prevent powder material 135 from falling out through first face 115 and second face 120. Several techniques can be applied to achieve this aim.

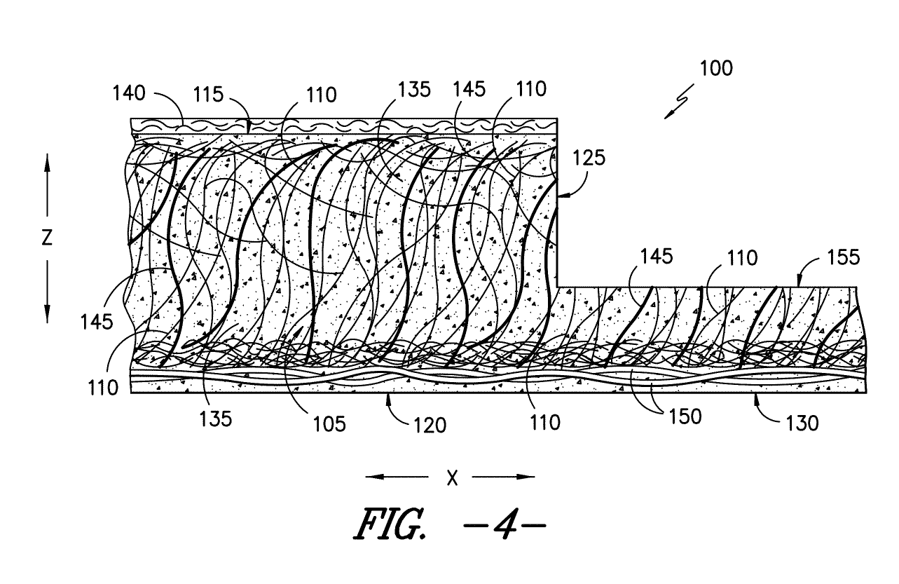

Firstly, as shown in FIG. 3, an additional layer 140 may be bonded or otherwise positioned onto first face 115 after the settable material has been introduced into the textile body. This additional layer 140 may be permeable to the liquid used to cause settable, powder material 135 to set and, if the permeability is brought about by the presence of pores in layer 140, such pores should be sufficiently small to prevent powder material 135 from falling through first face 115. Any suitable material may be used for layer 140 to seal first face 115. For example, a PVC layer may be used, which can be secured to first face 115 by a variety of techniques, for example by thermal welding or by means of an adhesive. Alternatively, layer 140 may be formed of a curable paste that is subsequently cured, e.g., using heat. Such a layer 140 is preferably thin, typically less than or equal to 1.5 mm, more preferably less than or equal to 0.5 mm. Layer 140 may be flexible to maintain the flexibility of the overall textile body prior to setting or hardening of powder material 135. Additional layers may be applied to sealing layer 140 by a variety of techniques, for example by thermal or chemical welding or by means of an adhesive. One such layer could be, by way of example, a damp-proof layer for applications in, e.g., the construction industry or tunneling.

Secondly, first face 115 may be made of, or include, an elastomeric yarn so that first face 115 can be stretched to enlarge pores within face 115 so as to allow the settable material to be introduced into textile body 105. Once powder material 135 has been added to textile body 105, the stretching forces can be released, to close the pores to a size such that powder material 135 cannot readily escape through first face 115.

Thirdly, first face 115 can be treated after powder material 135 has been introduced into textile body 105 so as to close the pores of first face 115. For example, it is possible to treat first face 115 by applying a sealing material such as an adhesive or subjecting first face 115 to solvent treatment to fully or partially close the pores. In one example, a PVC paste may be applied (for example using a scraper) to first face 115 and cured, for example, by heat by means of radiative heaters or hot air blowers.

Fourthly, first face 115 can be knitted from fibers that will shrink when heated, thereby enabling powder material 135 to be introduced through the knit having pores sufficiently open to allow the particles of powder material 135 to pass through. Once powder material 135 has been introduced into the textile body, first face 115 can be heated, e.g. using heated air, and the heat will cause the fibers to contract sufficiently to close the pores enough to substantially prevent the particles of powder material 135 from escaping. Such fibers that shrink when heated include the majority of thermoplastic fibers including e.g., polypropylene. The method of heating fibers to cause shrinkage described above may also have an advantage in compacting powder material 135, especially if such heat shrinkable fibers are also used to form the second face 120 and/or the supporting fibers 110.

Second face 120 is preferably substantially impervious to powder material 135 so that the settable material does not fall through second face 120 when added through first face 115. For example, second face 120 could be sealed by an adhesive or a film forming polymer to retain the settable powder material 135. The use of additional layers on second face 120 will be further described below.

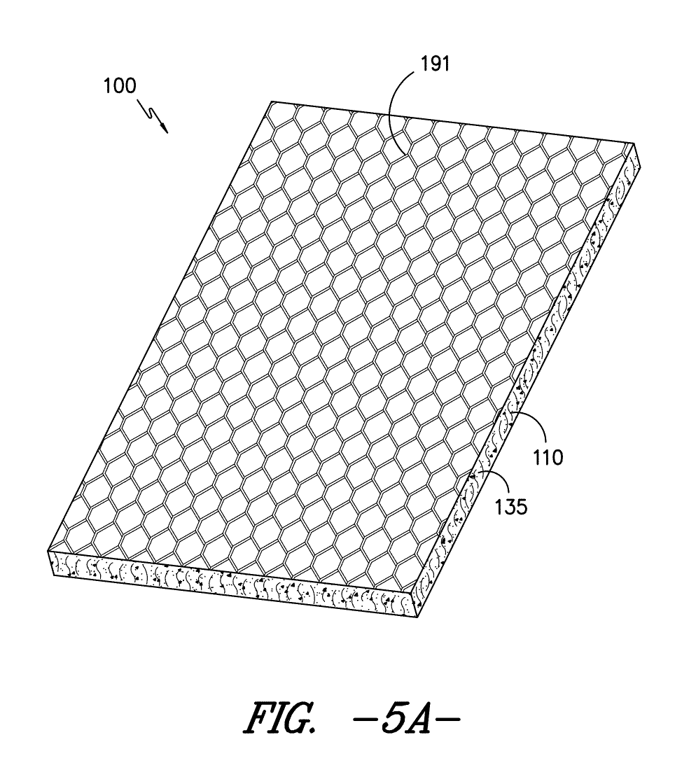

Textile 100 can also include reinforcement fibers 145 that improve its mechanical strength without unnecessarily increasing its weight. Such reinforcement fibers 145 can form all or part of textile body 105. For example, reinforcement fibers 145 could be dispersed throughout textile body 105 along with supporting fibers 110 as shown in FIG. 3. In another exemplary embodiment, supporting fibers 100 could all be reinforcement fibers 145. In another exemplary embodiment, first face 115, second face 120, or both, may contain reinforcement fibers 145. For example, such reinforcement fibers 145 could be included as high tensile strength yarns 150 that are positioned (woven or knit) along second face 120 as shown in FIG. 4. Yarns 150 could by incorporated over the entire length of second face 120 in direction X as shown or could be incorporated only partially along the length of second face 120 in direction X (or alternatively Y, Z, or any combination of the directions). As stated, yarns 150 could be incorporated along first face 115 as well.

The specific tensile strength of the reinforcement fibers 145 can be measured using ASTM D2101. In one exemplary embodiment, the specific tensile strength of the reinforcement fibers 145 is in the range of about 7 grams per denier to about 30 grams per denier. In still another exemplary embodiment, the specific tensile strength of the reinforcement fibers 145 is in the range of about 7 grams per denier to about 20 grams per denier.

The specific tensile modulus of the reinforcement fibers 145 can be measured using ASTM D2101. In one exemplary embodiment, the specific tensile modulus of the reinforcement fibers 145 is in the range of about 35 gram per denier to about 3500 grams per denier.

The ultimate elongation of the reinforcement fibers 145 can be measured using ASTM D2101. In one exemplary embodiment, the ultimate elongation of the reinforcement fibers 145 is in the range of about 1.5 percent to about 25 percent. In another exemplary embodiment, the ultimate elongation of the reinforcement fibers 145 is in the range of about 3 percent to about 25 percent. In still another exemplary embodiment, the ultimate elongation of the reinforcement fibers 145 is in the range of about 5 percent to about 25 percent.

A variety of different materials may be used to form the reinforcement fibers 145 of textile body 105, first face 115, and/or second face 120. Reinforcement fibers 145 used in textile body 105, first face 115, and/or second face 120 may include fibers created from a variety of materials.

The reinforcement fibers 145 used in textile body 105 may be staple or continuous. Some examples of suitable reinforcement fibers include glass fibers, aramid fibers, and highly oriented polypropylene fibers, bast fibers, and carbon fibers. A non-inclusive listing of suitable fibers for the reinforcement fibers 145 in textile body 105 can also include fibers made from highly oriented polymers, such as gel-spun ultrahigh molecular weight polyethylene fibers (e.g., SPECTRA® fibers from Honeywell Advanced Fibers of Morristown, N.J. and DYNEEMA® fibers from DSM High Performance Fibers Co. of the Netherlands), melt-spun polyethylene fibers (e.g., CERTRAN® fibers from Celanese Fibers of Charlotte, N.C.), melt-spun nylon fibers (e.g., high tenacity type nylon 6,6 fibers from Invista of Wichita, Kans.), melt-spun polyester fibers (e.g., high tenacity type polyethylene terephthalate fibers from Invista of Wichita, Kans.), and sintered polyethylene fibers (e.g., TENSYLON® fibers from ITS of Charlotte, N.C.). Suitable reinforcement fibers also include those made from rigid-rod polymers, such as lyotropic rigid-rod polymers, heterocyclic rigid-rod polymers, and thermotropic liquid-crystalline polymers. Suitable reinforcement fibers 145 made from lyotropic rigid-rod polymers include aramid fibers, such as poly(p-phenyleneterephthalamide) fibers (e.g., KEVLAR® fibers from DuPont of Wilmington, Del. and TWARON® fibers from Teijin of Japan) and fibers made from a 1:1 copolyterephthalamide of 3,4′-diaminodiphenylether and p-phenylenediamine (e.g., TECHNORA® fibers from Teijin of Japan). Suitable reinforcement fibers 145 made from heterocyclic rigid-rod polymers, such as p-phenylene heterocyclics, include poly(p-phenylene-2,6-benzobisoxazole) fibers (PBO fibers) (e.g., ZYLON® fibers from Toyobo of Japan), poly(p-phenylene-2,6-benzobisthiazole) fibers (PBZT fibers), and poly[2,6-diimidazo[4,5-b:4′,5′-e]pyridinylene-1,4-(2,5-dihydroxy)phenylene] fibers (PIPD fibers) (e.g., M5® fibers from DuPont of Wilmington, Del.). Suitable reinforcement fibers made from thermotropic liquid-crystalline polymers include poly(6-hydroxy-2-napthoic acid-co-4-hydroxybenzoic acid) fibers (e.g., VECTRAN® fibers from Celanese of Charlotte, N.C.). Suitable reinforcement fibers also include boron fibers, silicon carbide fibers, alumina fibers, glass fibers, and carbon fibers, such as those made from the high temperature pyrolysis of rayon, polyacrylonitrile (e.g., OPF® fibers from Dow of Midland, Mich.), and mesomorphic hydrocarbon tar (e.g., THORNEL® fibers from Cytec of Greenville, S.C.). In another exemplary embodiment, the reinforcement fibers 145 may be selected from alkali resistant fibers such as e.g., polyvinyl alcohol (PVA) fibers, polypropylene fibers, polyethylene fibers, etc. In still another exemplary embodiment, reinforcement fibers 145 having an alkali resistant coating may be used such as e.g., PVC coated glass fibers.

As set forth above, textile body 105 is equipped with flap 130 to facilitate joining textile 100 to another component such as e.g., one or more additional textiles 100. Flap 130 can be created through several different techniques. For example, support fibers 110 and/or reinforcement fibers 145 along an edge 125 of textile body 105 could be trimmed or shaved to create flap 130. In still another embodiment, second face 120 could be formed with high tensile strength yarns 150 that extend along second face of textile body 105 to form flap 130. As such, flap 130 could be formed in part from supporting fibers 110, reinforcement fibers 145, and yarns 150 as shown in FIG. 4. Alternatively, flap 130 could be formed solely from reinforcement yarns 150 extending past edge 125 to form flap 130.

In each of the above described configurations, flap 130 can still be integral with textile body 105. However, flap 130 can also be a separate element that is added to textile body 105 by e.g., mechanical means such as stitching.

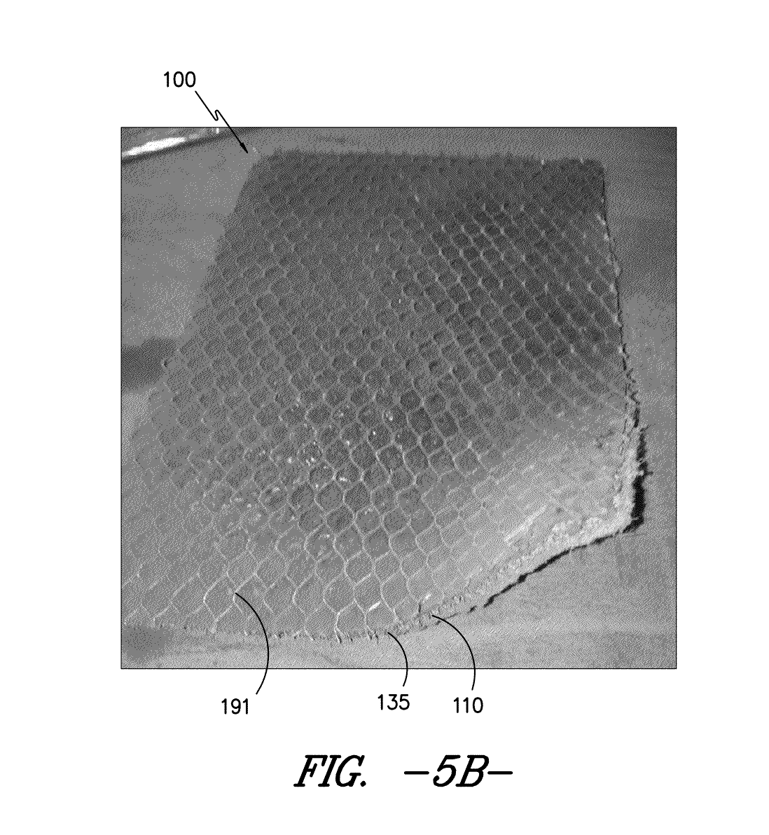

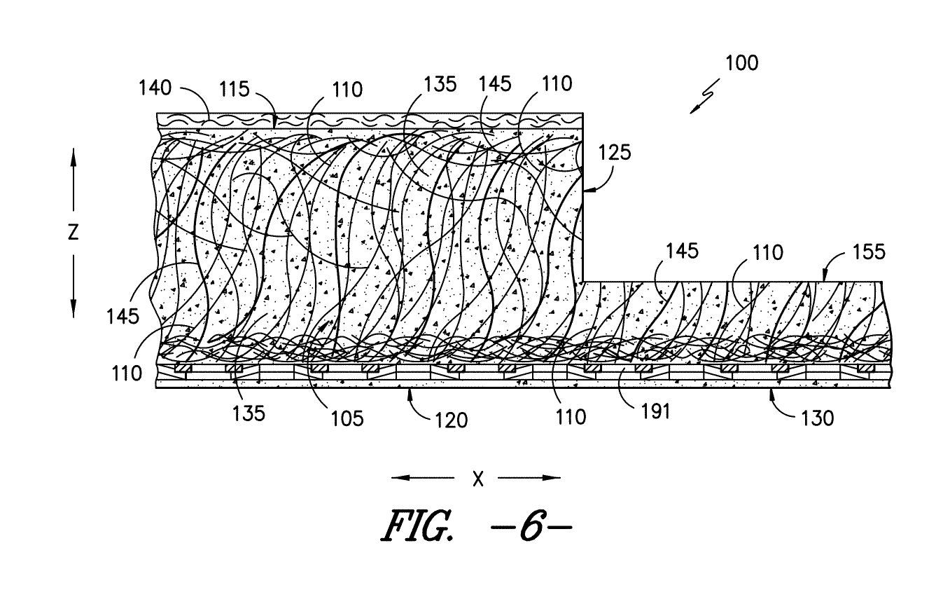

FIGS. 5A, 5B, and 6 illustrate additional exemplary embodiments of the present invention in which a metal lath 191 has been added as a reinforcement to textile body 105. As shown in FIGS. 5A and 5B, metal lath can be added to one of the faces of textile body 105. Metal lath 191 can be bonded to the textile body by e.g., polymers selected from the group consisting of PVC, HDPE, LLDPE, LDPE, flexible polypropylene fPP, chlorosulphonated polyethylene CSPE-R, and ethylene propylene diene terpolymer EPDM-R. The bonding agent may also form an impermeable layer or an impermeable layer may be incorporated as a separate element in the composite. Alternatively, as shown in FIG. 6, metal lath 191 can be incorporated directly into textile body 105. In addition, metal lath 191 can be extended into flap 130 to provide additional reinforcement for joining textile 100 to other components such as e.g., another textile 100. As an alternative to metal lath 191, metal mesh, metal wires, or a perforated metal sheet can be incorporated to provide such metal reinforcement.

The lath, perforated sheet, mesh, or wires of the metal reinforcement can be aligned principally at 90 degrees, 45 degrees or any other angle to the x-direction to provide reinforcement or stiffness that is uniaxial or acts along a specific axis. The hole size, shape, and other physical parameters may be adjusted, e.g., to accommodate ground anchors or to control limited strain take-up through deformation of the holes.

The metal reinforcement can be any grade of steel, including stainless and high tensile steels. The metal reinforcement can also be protected from environmental factors. For example, the metal reinforcement could be a steel protected from corrosion by galvanization, powder coating, dip coating, or painting. Other metals and alloys may be used such as e.g., aluminum alloys, brass, copper, or titanium.

Metal reinforcement such as metal lath 191 provides certain advantages for the construction of textile material 100. For example, such metal reinforcement can provide improved performance in tension when the textile body has not been set or hardened and can provided improved performance in bending when set. Additionally, such metal reinforcement is sufficiently ductile such that the unset textile material 100 can be rolled and stored, and then can also be unrolled and bent by hand into a desired shape. The metal reinforcement is also sufficiently stiff to retain the desired shape while still allowing the textile material to be flexible and to be wetted for hardening. The metal reinforcement may be electrically conductive so as to provide Electro Magnetic Field (EMF) insulation, earthing for electrical protection, and fault detection through resistive or capacitate measurement of the composites characteristics over time.

In addition to applications previously mentioned, applications for the metal reinforced textile 100 include e.g, vent and blast walls in mining, slope stabilization and slope protection, and roofing and architectural applications. Craft construction uses such as garden furniture, self-build features, tile backing board for curved surfaces, and others are also provided.

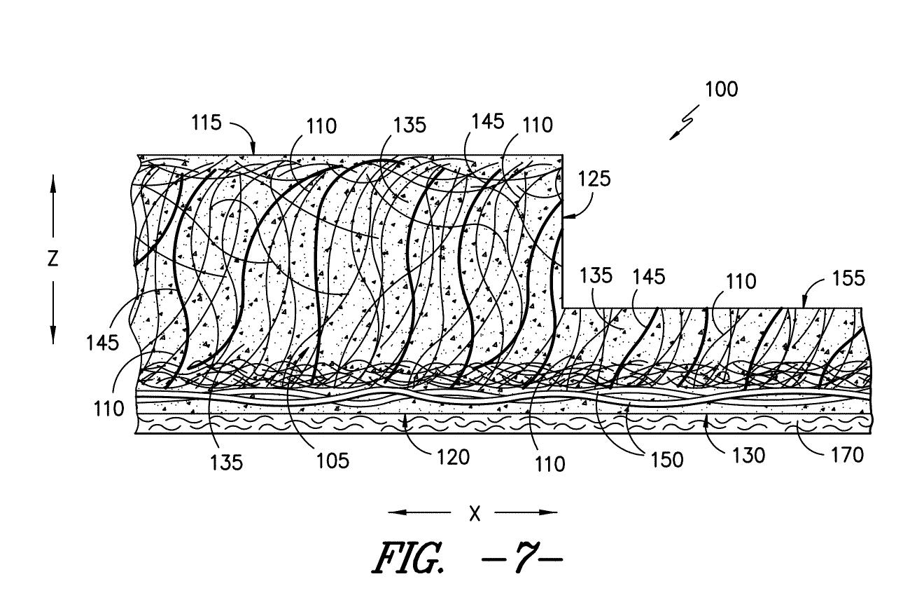

In another exemplary embodiment of the present invention, a liquid or vapor impermeable layer can be added to the first face or second face of the textile 100 of any of the previously described embodiments. For example, FIG. 7 illustrates an exemplary embodiment where reinforcing yarns 150 and a liquid or vapor impermeable layer 170 has been added to the textile 100 of the exemplary embodiment of FIG. 2. Liquid or vapor impermeable layer 170 can also be used e.g., to prevent powder material 135 from escaping through second face 120 during manufacture and installation of textile 100. Additionally, layer 170 could be used e.g., to help retain liquid added to textile 100 during installation so as to cause powder material 135 to create a rigid or semi-rigid solid located in the space between first face 115 and second face 120.

The liquid or vapor impermeable layer 170 can be constructed from various suitable materials. For example, layer 170 can include a polymer such as PVC, HDPE, LLDPE, LDPE, flexible polypropylene fPP, chlorosulphonated polyethylene CSPE-R, and/or ethylene propylene diene terpolymer EPDM-R. Other materials may be used as well. As stated, layer 170 could also be added to the exemplary embodiments of textile 100 shown in FIGS. 1 through 5. In one embodiment, liquid or vapor impermeable layer 170 may be about 0.5 mm in thickness along the z-direction. In another embodiment, liquid or vapor impermeable layer 170 may be PVC and have a thickness of about 9 mm or greater along the z-direction.

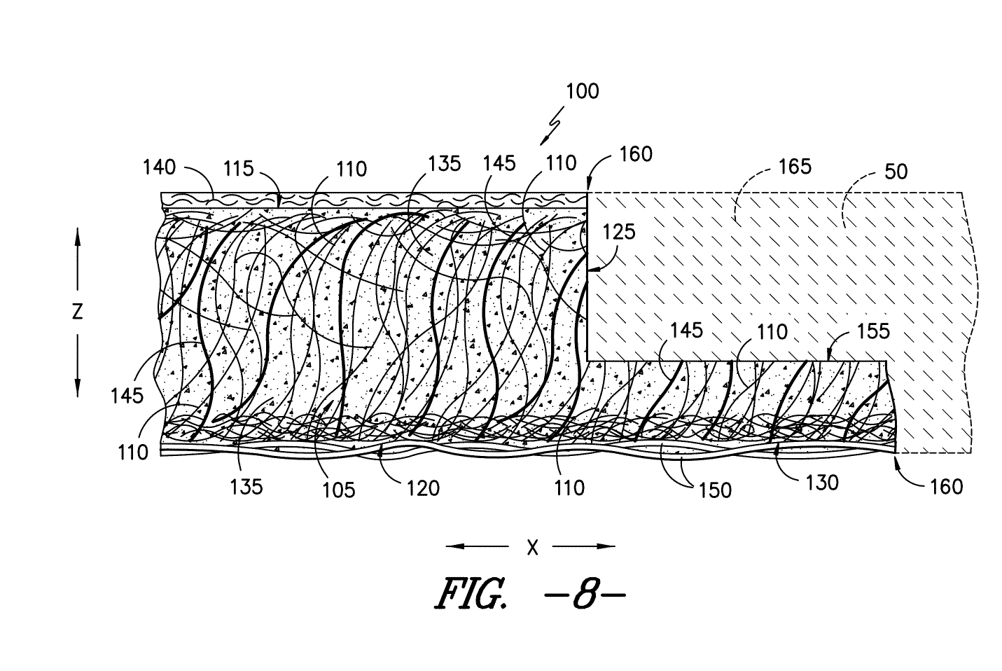

FIG. 8 illustrates textile 100 from the exemplary embodiment of FIG. 4 joined to another component 50. Component 50 can be e.g., another textile that is the same as or similar to textile 100 or could be another construction component. As such, flap 130 allows e.g., multiple sheets of textile 100 to be joined together to form the construction desired, such as e.g., a roadway, culvert, temporary structure, and many others as set forth above. Further, a joint 160 can be readily formed using flap 130 without necessarily using specialized construction equipment or highly trained labor. Joint 160 can be formed in a complementary manner as shown by using a component 50 having a mating distal end 165. Alternatively, other joints 160 may also be employed by using e.g., a non-mating distal end or other configurations.

To assist in forming joint 160 and interlocking textile 100 with component 50, an adhesive may be applied to inside surface 155 of flap 130 and optionally to edge 125 as well. Alternatively, a pressure sensitive adhesive with a releasable film can be allied to inside surface 155 and optionally to edge 125 as well. Flap 130 and component 50 could be equipped with hook and loop type fasteners. As will be understood by one of skill in the art using the teachings disclosed herein, still other methods may be employed to assist in using flap 130 to join textile 100 with another component.

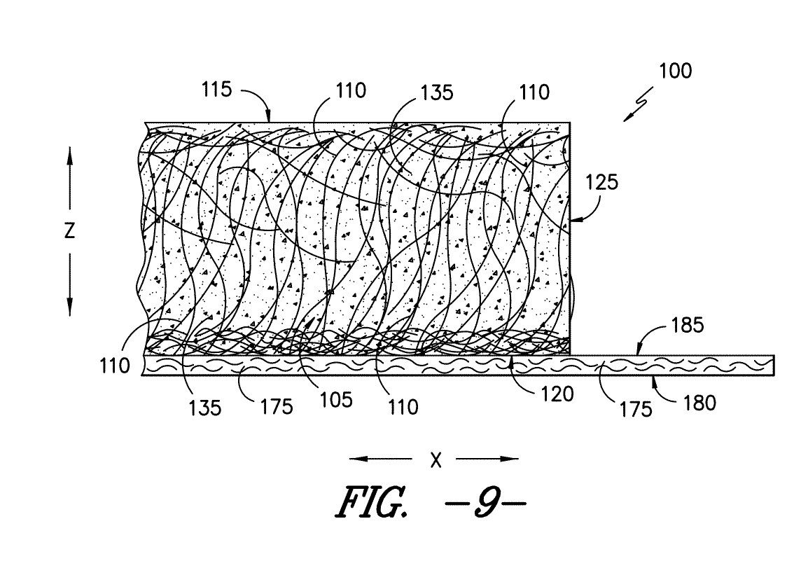

In another exemplary embodiment of the present invention, textile 100 can also be constructed with a reinforcement layer along first face 115, second face 120, or both. More particularly, FIG. 9 illustrates an exemplary embodiment of the present invention in which a reinforcement layer 175 is located on second face 120 of textile 100. As shown, reinforcement layer 175 extends past edge 125 of textile body 105 to define a flap 180 that may be used for joining textile 100 with another component as previously described.

Reinforcement layer 175 can include reinforcement fibers and/or reinforcement yarns such as fibers 145 and/or yarns 150 as previously described to impart additional mechanical strength to textile 100. Reinforcement layer 175 can also be constructed from reinforcement fibers that are arranged into a mesh pattern by orienting a first plurality of reinforcement fibers along a first direction of reinforcement layer 175 (such as the X direction shown in FIG. 9) and a second plurality of reinforcement fibers along a second direction of reinforcement layer 175 (such as a Y direction, which would be perpendicular to both the X direction and Z direction shown in FIG. 9). In such case, the first direction and the second direction could be provided at an angle in the range of about 20 degrees to about 90 degrees from each other. The mesh pattern can define gaps between the first and second plurality of reinforcement fibers. A polymer layer can be cured onto the reinforcement layer to bind the gaps between the reinforcement fibers. Such polymer could be e.g., PVC, HDPE, LLDPE, LDPE, flexible polypropylene fPP, chlorosulphonated polyethylene CSPE-R, and/or ethylene propylene diene terpolymer EPDM-R. Depending upon the desired application, a low wick finish could be applied to the reinforcement fibers of reinforcement layer 175. Low wick finishes include e.g., fluorocarbon based surfactants, perfluoroalkyl polyacrylate copolymer emulsion (Repearl F89), perfluorooctane based surfactant (3M F359), Alifan 5248A and Alifan 5248B by Clariant. Low wick yarns prevent water from penetrating the fabric, reducing mildew and mold stains to a minimum.

In FIG. 9, reinforcement layer 175 has been added to a textile body 105 having supporting fibers 110 similar to the embodiment of FIG. 2. However, reinforcement layer 175 could also be applied to a textile body 105 having supporting fibers 110 and reinforcing fibers 145 in a manner similar to other embodiments such as the embodiment of FIG. 3. In addition, textile 100 could include both a reinforcement layer 175 and a vapor or liquid impermeable layer such as layer 170 from the exemplary embodiment of FIG. 7. For example, reinforcement layer 175 could be applied to second face 120, and liquid or vapor impermeable layer 170 could be applied to reinforcement layer 175. A chemical finish can be applied to the reinforcement fibers of reinforcement layer 175 to bind the fibers to the liquid or vapor impermeable layer. In still another exemplary embodiment of the present invention, one layer could be used to provide both a reinforcement layer and a vapor or liquid impermeable layer. This combined function layer could be applied to e.g., second face 120.

Different techniques may be used to join reinforcement layer 175 with textile body 105. For example, reinforcement layer 175 could be attached to textile body 105 mechanically by e.g., stitching. Alternatively, additional fibers or yarns could be used to attach textile body 105 to reinforcement layer 175. In one embodiment, reinforcement layer 175 includes fibrous projections, and at least a portion of the fibrous projections extend at least partially into the textile body (through either the first or second face 115 or 120). These projections entangle with the fibers in textile body 105, enhancing the connection between the reinforcement layer 175 and textile body 105. In another embodiment, the reinforcement layer 175 can be laminated to textile body 105 using an adhesive.

In a manner similar to previous exemplary embodiments, the exemplary textile 100 of FIG. 9 can be provided with various features for joining flap 180 with another component such as e.g., another textile. For example, an adhesive, a pressure sensitive adhesive with removable film, or hook and loop type fasteners could be used along inside surface 185 and optionally edge 125 as previously described herein. Optionally, flap 180 can be provided by reinforcement layer 175 having fibrous projections along inside surface 185. More particularly, textile 100 defines a first direction, designated with arrows z in FIG. 9, that is perpendicular to the reinforcement layer 175, which lies in a plane along a second direction, designated with arrows x. Flap 180 can be equipped with fibrous projections that extend along the first direction (i.e., z-direction) and are made of, e.g., a high surface area and high tensile strength fiber that can mechanically entangle with another component (such as e.g., another textile 100 or other construction component) to which textile 100 is joined. Where textile 100 is joined with e.g., another similarly constructed textile having a settable powder material 135, the fibrous projections can interlock or join in such settable powder material to join the two textiles together.

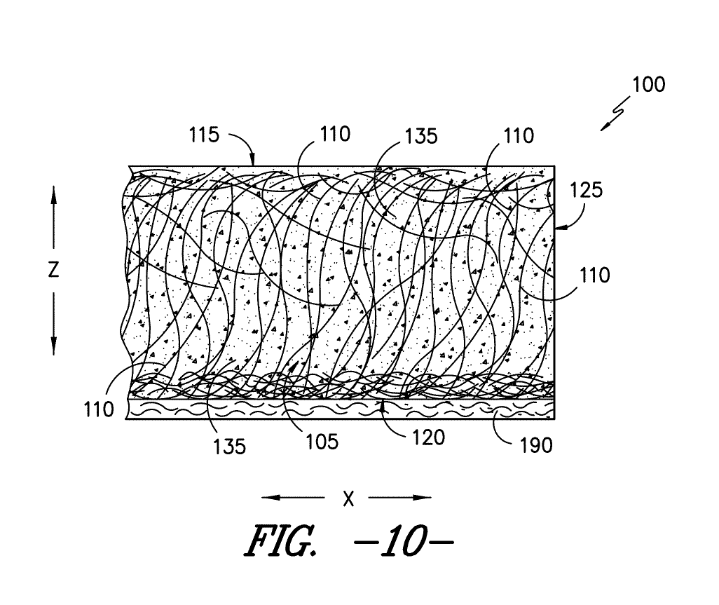

In another exemplary embodiment of the present invention, textile 100 can also be constructed with a reinforcement scrim along first face 115, second face 120, or both. More particularly, FIG. 10 illustrates an exemplary embodiment of the present invention in which a reinforcing scrim 190 is located on second face 120 of textile 100. As used herein, “scrim” means a textile fabric layer formed by a network of crossed yarns or fibers comprising at least one ply of weft yarns and one ply of warp yarns, wherein the warp & weft yarns are bonded together in engineered patterns.

Reinforcing scrim 190 can include reinforcement fibers and/or reinforcement yarns such as fibers 145 and/or yarns 150 as previously described to impart additional mechanical strength to textile 100. Scrim 190 can also be constructed with hybrid fibers, meaning e.g., fibers constructed from multiple reinforcing fiber types. For example, hybrid fibers can be used that are constructed from combinations of the materials previously identified for use in constructing reinforcement fibers 145.

In still other exemplary embodiments of the invention, scrim 190 could be constructed having a first type of reinforcing fiber in the weft direction and a second type of reinforcing fiber in the warp direction. These two different reinforcing fibers could have different mechanical properties such as different tensile moduli depending upon e.g., the intended application for textile 100. In still other embodiments, the reinforcing fibers in the weft direction and the warp direction could have different densities (i.e., a different number of fiber ends per inch). As previously described, the reinforcing fibers used in reinforcing scrim 190 could be constructed from alkali resistant fibers or from fibers having an alkali resistant coating.

In FIG. 10, reinforcing scrim 190 has been added to a textile body 105 having supporting fibers 110 similar to the embodiment of FIG. 2. However, scrim 190 could also be applied to a textile body 105 having supporting fibers 110 and reinforcing fibers 145 in a manner similar to other embodiments such as the embodiment of FIG. 3. In addition, textile 100 could include both a reinforcing scrim 190 and a vapor or liquid impermeable layer such as layer 170 from the exemplary embodiment of FIG. 7. For example, reinforcing scrim 190 could be applied to second face 120 and a liquid or vapor impermeable layer 170 could be applied to scrim 190.

A scrim can also be used to form a textile having a flap extending past the textile body. For example, returning to FIG. 9, reinforcement layer 175 could comprise a scrim constructed as previously described and extending past edge 125 to form flap 180 for joining to other components (also as previously described).

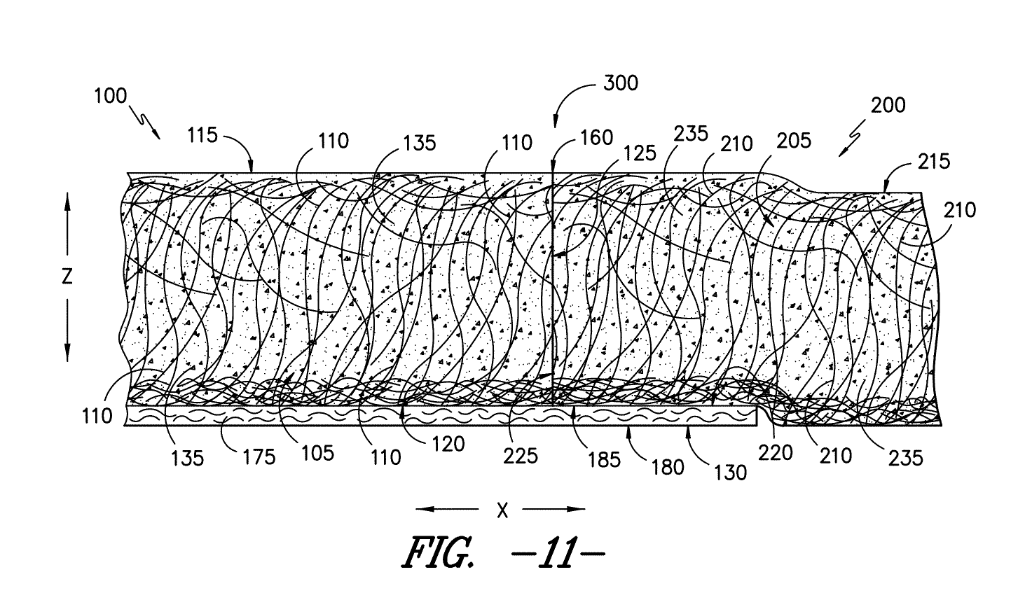

FIG. 11 illustrates a cross-sectional view of an exemplary embodiment of a textile composite 300 of the present invention. Textile composite 300 can be formed as a flexible sheet that can be set to become rigid or semi-rigid. For example, as with previously described embodiments, the addition of a liquid and/or the application of radiation can be used to convert textile composite 300 from a flexible to a rigid or semi-rigid composite.

As depicted, textile composite 300 is formed by joining a first flexible textile 100 and with a second flexible textile 200. Each textile 100 and 200 can be set to become rigid or semi-rigid and each can be constructed as set forth above for any of the previously described embodiments. For example, textile 100 includes a first face 115 and a second face 120. A textile body 105 includes supporting fibers 110 that extend between first and second faces 115 and 120 to maintain such faces in a spaced apart relationship. A powder material 135 is located in the space between the first and second faces 115 and 120, having properties as previously described. Similarly, textile 200 includes a first face 215 and a second face 220. A textile body 205 includes supporting fibers 210 that extend between first and second faces 215 and 220 to maintain such faces in a spaced apart relationship. A powder material 235 is located in the space between the first and second faces 215 and 220, also having properties as previously described. As with previously described embodiments, textile bodies 105 and 205 can each including reinforcing fibers and/or yarns having mechanical properties as described with previous exemplary embodiments.

For the exemplary embodiment of FIG. 11, first flexible textile 100 includes a reinforcement layer 175 located on second face 120. As shown, at least a portion of reinforcement layer 175 extends past textile body 105 of first flexible textile 100 to define a flap 130 that overlaps at least a portion of textile body 205 of second flexible textile 200. For this exemplary embodiment, textiles 100 and 200 are formed as sheets that are joined by butting edge 125 of textile 100 with edge 225 of textile 200 to create a flat, non-overlapping joint 160. In order to secure textile 100 and 200 together as shown, flap 130 can be provided with features as previously described. Accordingly, flap 130 could include e.g., fibrous projections for interlocking or entangling with the fibrous material of 210 and buried in the powder material 235 of textile body 205. When powder material 235 is hardened, such fibrous projections will become locked into textile body 205. Alternatively, an adhesive could be used to join flap 130 to textile body 205. Other techniques may be used as well.

In other exemplary embodiments of the invention, flap 130 could extend from first face 115 of first flexible textile 100. Conversely, the first or second face 215 or 220 of the second flexible textile could include a reinforcing layer that provides a flap overlapping textile body 105 of first flexible textile 100. Such reinforcement layer can include reinforcing fibers or yarns having mechanical properties as set forth above. A liquid or vapor impermeable layer could also be added to one or both of textiles 100 and 200 as previously described.

The present invention may be better understood with reference to the following examples.

### Example 1 (E1)

An alumina rich cement was loaded into a 5 mm thick spacer fabric using a vibration and brushing technique to form a powder-filled textile body. The spacer fabric was made of knitted PET and had a tightly knitted second face layer and a more loosely knitted first face layer, with linking monofilament yarns extending across the space between the first and second faces. After the cement filling step, a 92 gram per square meter weft insertion warp knit scrim (warp direction: 1000 denier PET, 9 yarns per inch; fill direction: 1000 denier PET, 9 yarns per inch) was let off onto the second face and a PVC plastisol was knife coated and cured onto the second face to form a tear resistant water impermeable film. The PVC plastisol encapsulated and bridged the grid space between the reinforcement yarns and served as a load transfer matrix for the PET reinforcement yarns in the scrim. Water was used to set the cement.

### Example 2 (E2)

An alumina rich cement was loaded into an 8 mm thick spacer fabric using a vibration and brushing technique to form a powder-filled textile body. The spacer fabric was made of knitted PET and had a tightly knitted second face layer and a more loosely knitted first face layer, with linking monofilament yarns extending across the space between the first and second faces. After the cement filling step, a 92 gram per square meter weft insertion warp knit scrim (warp direction: 1000 denier PET, 9 yarns per inch; fill direction: 1000 denier PET, 9 yarns per inch) was let off onto the second surface and a PVC plastisol was knife coated and cured onto the second surface to form a tear resistant water impermeable film. The PVC plastisol encapsulated and bridged the grid space between the reinforcement yarns and served as a load transfer matrix for the PET reinforcement yarns in the scrim. Water was used to set the cement.

### Example 3 (E3)

An alumina rich cement was loaded into an 8 mm thick spacer fabric using a vibration and brushing technique to form a powder-filled textile body. The spacer fabric was made of knitted PET and had a tightly knitted second face layer and a more loosely knitted first face layer, with linking monofilament yarns extending across the space between the first and second face layers. After the cement filling step, a 160 gram per square meter acrylic coated STABILON laid scrim (warp direction: H18 single ply 0.7 Z-Twist high tenacity fiberglass from B&W, 4 yarns per inch; fill direction: H18 single ply 0.7 Z-Twist high tenacity fiberglass from B&W, 4 yarns per inch) was let off onto the second surface and a PVC plastisol was knife coated and cured onto the second surface to form a tear resistant water impermeable film. The PVC plastisol encapsulated and bridged the grid space between the reinforcement yarns and served as a load transfer matrix for the glass reinforcement yarns in the scrim. In addition, the PVC coating served to make the glass yarns more resistant to alkali attack. Water was used to set the cement.

### Example 4 (E4)

An alumina rich cement was loaded into an 8 mm thick spacer fabric using a vibration and brushing technique to form a powder-filled textile body. The spacer fabric was made of knitted PET and had a tightly knitted second face layer and a more loosely knitted first face layer, with linking monofilament yarns extending across the space between the first and second face layers. After the cement filling step, a 44 gram per square meter tri-axially bonded mesh composed of high-modulus type Vinylon (PVA) filaments available from Unitika of Osaka, Japan (tensile strength per warp and diagonal filament is 215N) was let off onto the second surface and an amorphous polyalphaolefin (Vestoplast 704) was applied onto the second surface using a hot melt applicator to form a water impermeable film. The polyolefin encapsulated and bridged the grid space between the reinforcement yarns and served as a load transfer matrix for the PVA reinforcement yarns in the scrim. The tri-axial mesh has higher resistance against burst, tear, and shear and has higher impact strength when compared to a bi-axial mesh design. In addition, PVA and polyolefins have good resistance to chemicals (alkali, acids, etc.) and are particularly useful in secondary containment applications. Also, the PVA filaments have good affinity to cement and can chemically bond to the filled cement when hydrated. Water was used to set the cement.

### Example 5 (E5)

An alumina rich cement was loaded into a 8 mm thick spacer fabric using a vibration and brushing technique to form a powder-filled cloth. The spacer fabric was made of knitted PET and had a tightly knitted second face layer and a more loosely knitted first face layer, with linking monofilament yarns extending across the space between the first and second face layers. After the cement filling step, an amorphous polyalphaolefin (Vestoplast 704) was applied onto the second surface using a hot melt applicator to form a water impermeable film and a 175 gram per square meterSTABILON composite scrim (warp direction: G37 glass, 7.5 yarns per inch; fill direction: G37 glass, 7.5 yarns per inch, 30 grams per square meter (gsm) glass mat backing) was laminated onto the polyolefin layer. Water was used to set the cement.

### Comparative Example 1 (C1)

A 5 mm thick spacer fabric was filled with an alumina rich cement. Water was used to set the cement. The spacer fabric was made of knitted PET and had a tightly knitted second face layer and a more loosely knitted first face layer, with linking monofilament PET yarns extending across the space between the first and second faces.

### Comparative Example 2 (C2)

An 8 mm thick spacer fabric was filled with an alumina rich cement. Water was used to set the cement. The spacer fabric was made of knitted PET and had a tightly knitted second face layer and a more loosely knitted first face layer, with linking monofilament PET yarns extending across the space between the first and second faces.

### Comparative Example 3 (C3)

A 13 mm spacer fabric was filled with an alumina rich cement. Water was used to set the cement. The spacer fabric was made of knitted PET and had a tightly knitted second face layer and a more loosely knitted first face layer, with linking monofilament yarns extending across the space between the first and second faces.

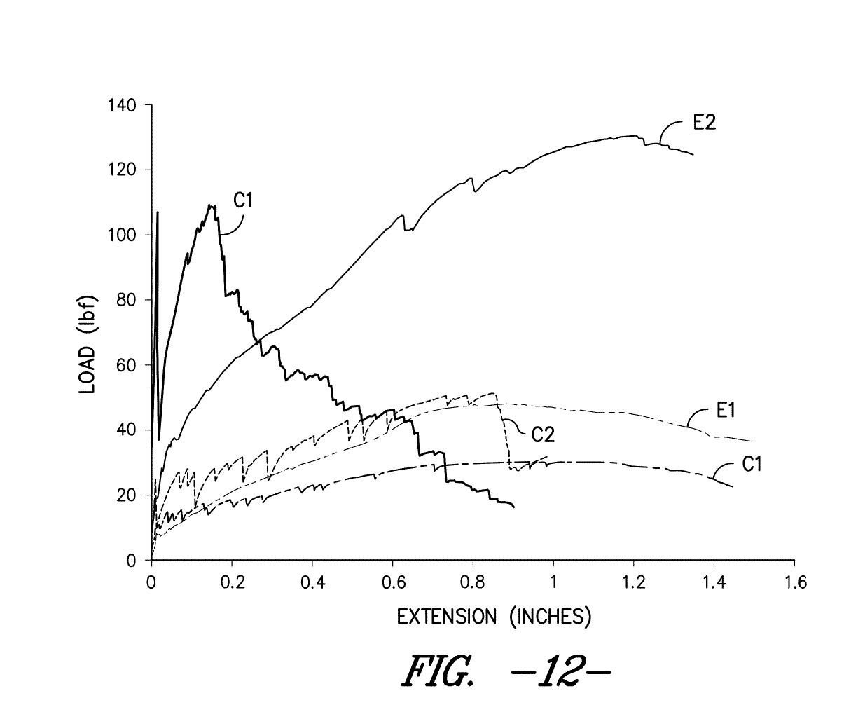

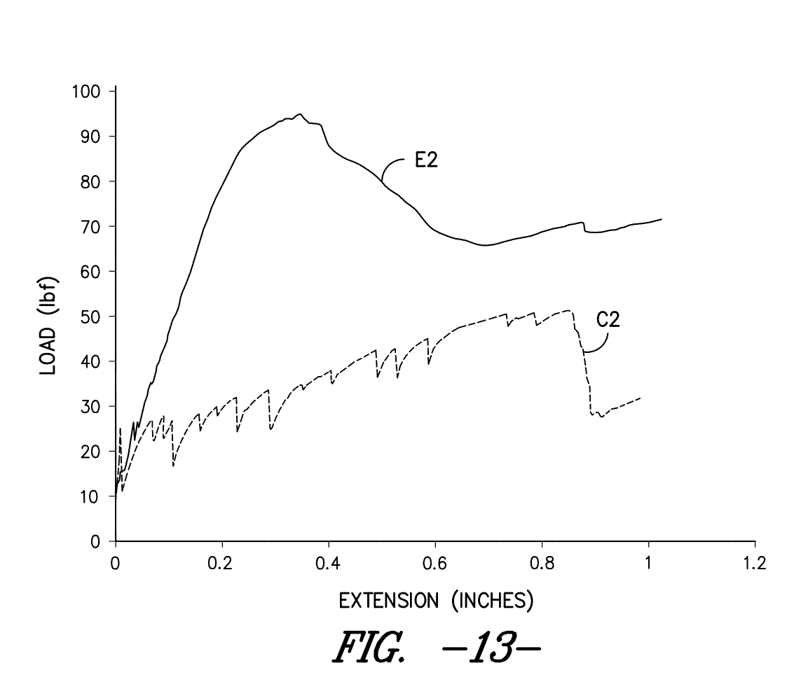

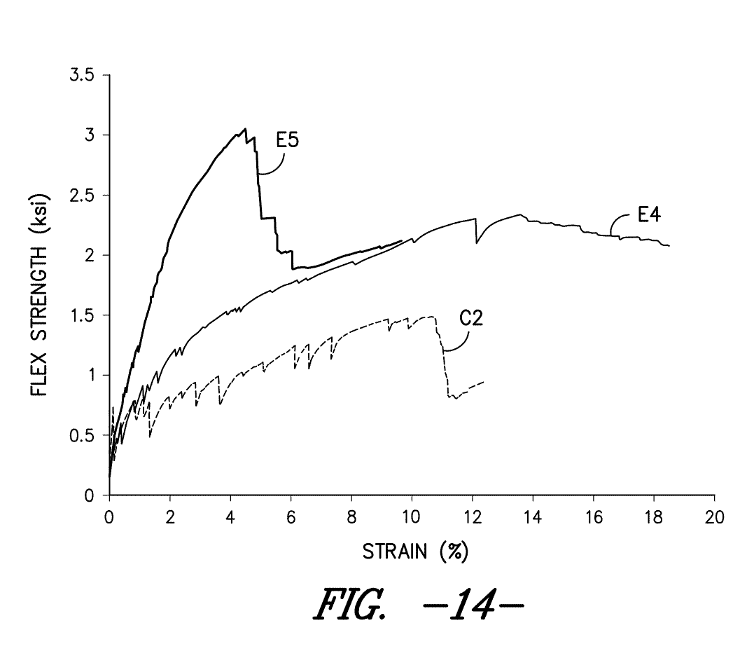

FIGS. 12, 13, and 14 provide data plots of the results of three-point bend testing using the examples prepared as described above. The three-point bend testing or flexural testing was conducted according to ASTM D 790 using an MTS mechanical testing machine. The modulus of elasticity in bending, strength, and toughness was calculated from the measured flexural stress-strain response of the composite material.

Two inch by six inch samples were cut and the test specimens were conditioned at 23° C.±2° C. and 50%±5% relative humidity for at least 40 hours prior to testing. The testing was conducted under the same temperature and humidity conditions. The thickness of each sample was measured using a micrometer with a clutch or vernier caliper. The MTS mechanical testing machine for flexural testing was set up by placing test samples of rectangular cross section on two supports set at a span of 100 mm (4 inches). Samples were loaded by means of a loading nose midway between the supports. The loading nose and supports have cylindrical surface geometries to avoid excessive indentation or failure due to stress concentration directly under the loading nose. The loading nose and supports were aligned so that the axes of the cylindrical surfaces are parallel and the loading nose is midway between the supports. The test samples were centered on the supports with the long axis of the samples perpendicular to the loading nose. The MTS mechanical testing machine was set for a rate of crosshead speed of 1 inch/min. The load cell was calibrated such that error in the load measuring system should not exceed ±1° A). The load was then applied to the test samples at the specified crosshead rate and simultaneous load-deflection data was recorded. The deflection was measured from the motion of the loading nose relative to the supports. Load-deflection curves were then plotted to determine the tangent modulus of elasticity, flexural strength, and the total work as measured by the area under the load-deflection curve.

As demonstrated by FIGS. 12, 13, and 14, the addition of a reinforcement layer to the space fabric substantially improved the mechanical strength of the resulting textile. Furthermore, the choice of reinforcement can dictate the strain to failure of the composite material. For example, the composite material with glass reinforcement (Example 3) has a lower strain to failure when compared with a composite material with high tenacity PET reinforcement (Example 2).

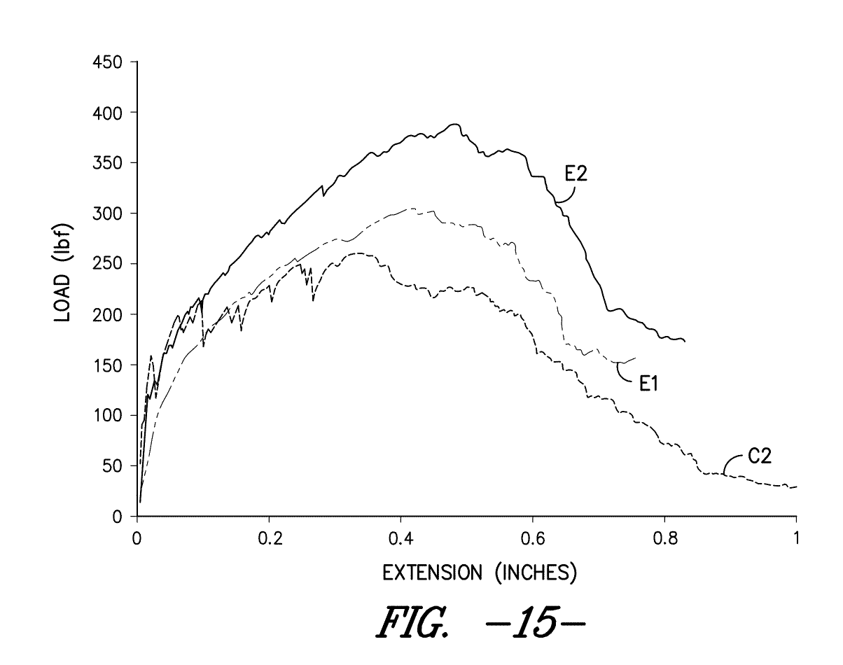

FIG. 15 provides the results a shear test method using E1, E2, and C2. For the test, 3 inch by 5 inch samples were connected at each end to 3 inch by 5 inch plates of galvanized steel by means of self-tapping screws centered at 1 inch from the end to form a test specimen. This arrangement was intended to apply pure shear to the screw and to avoid any prying or bending of the screw, which would have made interpretation of the results difficult. The 5 inch dimension of each sample was oriented in the roll length or machine direction. The test specimens were then immersed in potable water at 68° F. for 3 days to allow the sample to hydrate and cure. Subsequent to hydration, the samples were stored for 2 weeks in a lab at 68° F. and ˜50% relative humidity before testing.

The samples were then mounted into an MTS Sintech 10/G electro-mechanical tensile testing machine (available from MTS Systems Corporation) to apply a tensile load. Elongations at incremental applications of a tensile load were recorded so that load elongation curves could be plotted along with corresponding modulus calculations. The 16 gauge galvanized steel plates and the McMaster-Carr Sealing Hex Head Sheet Metal Screw, Weather Resist Coated Steel, Silver, #10 Size, 1″ Length (called Screw 2 in Phase 1) were used for all the samples. The screw location was precisely 1 inch from the free edge of the sample in the middle of the width of the sample or 1.5 inches from the center to the free edge.

Without being bound to any particular theory, it is believed there are three possible failure modes: 1) a tension failure of either the steel or the sample, 2) a shear failure through the shank of the screw, and 3) a bearing failure of the sample that bears or is in contact with the screw. In the machine-direction, the bearing of the screws on the sample, after cracking the concrete, essentially elongated and tore through the three-dimensional fiber matrix of the sample. As shown in FIG. 15, a 50% higher bearing stress was achieved in the PET scrim reinforced samples in both machine and cross-machine directions.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A flexible textile that can be set to become rigid or semi-rigid, the textile comprising:
a first face;
a second face separated from the first face by a space;
a textile body comprising supporting fibers extending between the first and second faces and maintaining the first and second faces in a spaced-apart arrangement;
a powder material located in the space between the first and second faces, wherein the powder material is capable of setting to a rigid or semi-rigid solid on the addition of a liquid or when exposed to radiation;
a liquid or vapor impermeable layer positioned on the second face; and,
a reinforcement layer located on the first face, wherein at least a portion of the reinforcement layer extends past the textile body to define a flap.

2. A flexible textile as in claim 1, further comprising an adhesive applied to the flap.

3. A flexible textile as in claim 1, wherein the reinforcement layer provides a surface having fibrous projections, wherein at least a portion of the fibrous projections extend at least partially into the textile body.

4. A flexible textile as in claim 1, wherein the flexible textile defines a first direction perpendicular to the reinforcement layer, wherein the reinforcement layer comprises fibrous projections having a high surface area projecting along the first direction for interlocking with another component.

5. (canceled)

6. A flexible textile as in claim 1, wherein the reinforcement layer comprises fibers that are selected from the group consisting of alkali resistant fibers and fibers having an alkali resistant coating.

7. A flexible textile as in claim 1, wherein the reinforcement layer comprises fibers having a specific tensile strength in the range of about 7 grams per denier to about 30 grams per denier.

8. A flexible textile as in claim 1, wherein the reinforcement layer comprises a scrim.

9. A rigid or semi-rigid textile, comprising:
a first face;
a second face separated from the first face by space;
a textile body comprising supporting fibers extending between the first and second faces and maintaining the first and second faces in a spaced-apart arrangement;
a rigid or semi-rigid solid located in the space between the first and second faces;
a liquid or vapor impermeable layer positioned on the second face; and,
a reinforcement layer located on the first face, wherein at least a portion of the reinforcement layer extends past the textile body to define a flap.

10. A flexible textile composite that can be set to become rigid or semi-rigid, the textile composite comprising:
a first flexible textile that can be set to become rigid or semi-rigid;
a second flexible textile that can be set to become rigid or semi-rigid;
wherein the first flexible textile and the second flexible textile each comprise:
a first face;
a second face separated from the first face by a space;
a textile body comprising supporting fibers extending between the first and second faces and maintaining the first and second faces in a spaced-apart arrangement;
a powder material located in the space between the first and second faces, wherein the powder material is capable of setting to a rigid or semi-rigid solid on the addition of a liquid or when exposed to radiation,
a liquid or vapor impermeable layer positioned on the second face; and,
wherein the first flexible textile further comprises a reinforcement layer located on the first face of the first flexible textile, wherein at least a portion of the reinforcement layer extends past the textile body of the first flexible textile to define a flap that overlaps at least a portion of the textile body of the second flexible textile.

11. (canceled)

12. A flexible textile composite as in claim 10, wherein the reinforcement layer comprises reinforcement fibers that are selected from the group consisting of alkali resistant fibers and fibers having an alkali resistant coating.

13. A flexible textile composite as in claim 10, further comprising an adhesive that secures the flap to the textile body of the second flexible textile.

14. A flexible textile composite as in claim 10, wherein the reinforcement layer comprises fibrous projections having a high surface area that are configured to project into the second flexible textile.

15. A rigid or semi-rigid textile composite, comprising:
a first rigid or semi-rigid textile;
a second rigid or semi-rigid textile, wherein the first rigid or semi-rigid textile and the second rigid or semi-rigid textile each comprise:
a first face;
a second face separated from the first face by a space;
a textile body comprising supporting fibers extending between the first and second faces and maintaining the first and second faces in a spaced-apart arrangement;
a rigid or semi-rigid solid located in the space between the first and second faces,
a liquid or vapor impermeable layer positioned on the second face; and,
wherein the first rigid or semi-rigid textile further comprises a reinforcement layer located on the first face of the first rigid or semi-rigid textile, wherein at least a portion of the reinforcement layer extends past the textile body of the first rigid or semi-rigid textile to define a flap that overlaps at least a portion of the textile body of the second rigid or semi-rigid textile.

16. (canceled)

17. A rigid or semi-rigid textile composite as in claim 15, wherein the reinforcement layer comprises reinforcement fibers that are selected from the group consisting of alkali resistant fibers and fibers having an alkali resistant coating.

18. A rigid or semi-rigid textile composite as in claim 15, wherein the reinforcement layer comprises fibrous projections having a high surface area that are entangled within the textile body of the second rigid or semi-rigid textile.

19-30. (canceled)
